(19) United States
(12) Patent Application Publication
(10) Pub. No.: US 2025/0068830 A1
(43) Pub. Date: Feb. 27, 2025

(54) EXTRACTING IMAGES TO SELECT AN OPTIMAL FONT BASED ON COMPUTERIZED SENTIMENT ANALYSIS

(71) Applicant: International Business Machines Corporation, Armonk, NY (US)

(72) Inventors: Kristin E. McNeil, Charlotte, NC (US); Radha Mohan De, Howrah (IN); ITAI GORDON, Modiin (IL); Dhruv Khurana, Marietta, GA (US)

(21) Appl. No.: 18/452,852

(22) Filed: Aug. 21, 2023

(51) Int. Cl. G06F 40/109; G06V 10/56; G06V 30/262

(52) U.S. Cl. CPC G06F 40/109; G06V 10/56; G06V 30/262

(57) ABSTRACT

A method, computer program product and/or system that performs the following operations (not necessarily in the following order): (i) receiving an input image (for example, a photograph) that includes a image portion and “caption text” (for example, an overlaid caption or some text that is captured in a photograph); (ii) extracting the caption text from the input image; (iii) extracting a plurality of image attributes relating to the caption text and image portion; (iv) applying sentiment analysis to the plurality of image attributes to select a selected font determining a sentiment associated with the plurality of image attributes; and (iv) generating an output image that includes the image portion of the input image and the caption text presented in the selected font.

### BACKGROUND

The present invention relates generally to the field of design of visual images that include text.

Artificial Intelligence (AI) is growing rapidly in adoption. Many companies are exploring new AI solutions, and AI is used in many contexts and applications. Artificial Intelligence relies heavily on the text it is analyzing. Most techniques today focus on the words in the text and not on the font style used for the text. However, to a human, the interpretation of the font has an inferred meaning. In the marketing field, workers manually design flyers and advertising materials by selecting specific font to convey a message.

The Wikipedia entry for “computer fonts” (as of 10 Feb. 2023) states, in part, as follows: “A computer font is implemented as a digital data file containing a set of graphically related glyphs. A computer font is designed and created using a font editor. A computer font specifically designed for the computer screen, and not for printing, is a screen font. In the terminology of movable metal type, a font is a set of pieces of movable type in a specific typeface, size, width, weight, slope, etc. (for example, Gill Sans bold 12 point or Century Expanded 14 point), and a typeface refers to the collection of related fonts across styles and sizes (for example, all the varieties of Gill Sans). In HTML, CSS, and related technologies, the font family attribute refers to the digital equivalent of a typeface. Since the 1990s, many people use the word font as a synonym for typeface. There are three basic kinds of computer font file data formats: Bitmap fonts consist of a matrix of dots or pixels representing the image of each glyph in each face and size. Vector fonts (including, and sometimes used as a synonym for, outline fonts) use Bézier curves, drawing instructions and mathematical formulae to describe each glyph, which make the character outlines scalable to any size. Stroke fonts use a series of specified lines and additional information to define the size and shape of the line in a specific typeface, which together determine the appearance of the glyph.” (footnotes omitted)

The Wikipedia entry for “sentiment analysis” (as of 31 Jul. 2023) states, in part, as follows: “Sentiment analysis (also known as opinion mining or emotion AI) is the use of natural language processing, text analysis, computational linguistics, and biometrics to systematically identify, extract, quantify, and study affective states and subjective information. Sentiment analysis is widely applied to voice of the customer materials such as reviews and survey responses, online and social media, and healthcare materials for applications that range from marketing to customer service to clinical medicine. With the rise of deep language models . . . more difficult data domains can be analyzed, e.g., news texts where authors typically express their opinion/sentiment less explicitly . . . . A basic task in sentiment analysis is classifying the polarity of a given text at the document, sentence, or feature/aspect level—whether the expressed opinion in a document, a sentence or an entity feature/aspect is positive, negative, or neutral. Advanced, “beyond polarity” sentiment classification looks, for instance, at emotional states such as enjoyment, anger, disgust, sadness, fear, and surprise . . . . A dictionary of extraction rules has to be created for measuring given expressions. Over the years, in subjective detection, the features extraction progression from curating features by hand to automated features learning. At the moment, automated learning methods can further separate into supervised and unsupervised machine learning. Patterns extraction with machine learning process annotated and unannotated text have been explored extensively by academic researchers . . . . Existing approaches to sentiment analysis can be grouped into three main categories: knowledge-based techniques, statistical methods, and hybrid approaches . . . . Statistical methods leverage elements from machine learning such as latent semantic analysis, support vector machines, “bag of words”, ‘Pointwise Mutual Information’ for Semantic Orientation, semantic space models or word embedding models, [49] and deep learning. More sophisticated methods try to detect the holder of a sentiment (i.e., the person who maintains that affective state) and the target (i.e., the entity about which the affect is felt).” (footnotes omitted) It is noted that the “extraction rules” and “extraction progression” mentioned in the excerpt above is not the same, and not related to, extraction of images, which will be discussed below.

Publish patent application JP2020154951A (“YOSHIHARI”) discloses a system that uses computerized software to select a font used in a caption for an image: “The font selection system 100 shown in FIG. 1 is a system including a font selection device 1 and a terminal 4. The font selection device receives information (image data) about the layout being created including the text to be selected as the font from the terminal 4, and acquires the text and the format information about the text from the received information about the layout. Then, the font selection device takes the acquired text and the format information related to the text as input, and acquires the font for the text using the trained model. After that, the font selection device presents the acquired font to the terminal . . . . The font selection device is a device that selects a font from text and format information related to the text by using a trained model for selecting a font.” (Reference numerals omitted from quoted text.) It is noted that YOSHIHARI does not disclose the use of sentiment analysis in selecting the font and also does not disclose extracting features from the text caption itself and does not disclose extracting features of a “media” or “multimedia source” (that is, an image, an audio clip, or a video clip).

### SUMMARY

According to an aspect of the present invention, there is a method, computer program product and/or system that performs the following operations (not necessarily in the following order): (i) receiving an input image (for example, a photograph) that includes a image portion and “caption text” (for example, an overlaid caption or some text that is captured in a photograph); (ii) extracting the caption text from the input image; (iii) extracting a plurality of image attributes relating to the caption text and image portion; (iv) applying sentiment analysis to the plurality of image attributes to select a selected font optimized for sentiment(s) associated with the plurality of image attributes; and (iv) generating an output image that includes the image portion of the input image and the caption text presented in the selected font. In some embodiments, where the application of sentiment analysis is based on application of a sentiment analysis model to the plurality of image attributes. In some embodiments, the sentiment analysis model considers events and circumstances (for example, formal/casual, fun/serious, etc.), spatiotemporal information (for example, where and when contextual info), errors in text, jargon, geographical related phrases, social status, intent of content, sociocultural norms/socially accepted behaviors, a target audience (that is, expected viewers' or listeners characteristics/attributes).

According to an aspect of the present invention, there is a method, computer program product and/or system that performs the following operations (not necessarily in the following order): (i) receiving a video image (for example, an audiovisual presentation) that includes a video portion and “caption text” (for example, an overlaid caption or some text that is captured in the video); (ii) extracting the caption text from the video image; (iii) extracting a plurality of video attributes relating to the caption text and video portion; (iv) applying sentiment analysis to the plurality of video attributes to select a selected font optimized for sentiment(s) associated with the plurality of video attributes; and (iv) generating an output video presentation that includes the video portion of the video image and the caption text presented in the selected font.

According to an aspect of the present invention, there is a method, computer program product and/or system that performs the following operations (not necessarily in the following order): (i) receiving an audio presentation (for example, a web page with a link to an audio portion) that includes an audio portion and “caption text” (for example, web page text describing the content of the linked audio presentation); (ii) extracting the caption text from the image; (iii) extracting a plurality of video attributes relating to the caption text and video portion; (iv) applying sentiment analysis to the plurality of video attributes to select a selected font optimized for sentiment(s) associated with the plurality of image attributes; and (iv) generating an output audio presentation that includes the video portion of the video image and the caption text presented in the selected font.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4A is an example to which the method of the present invention can be applied; and

FIG. 4B shows the output when the method of the present invention has been applied to the image shown in FIG. 4A.

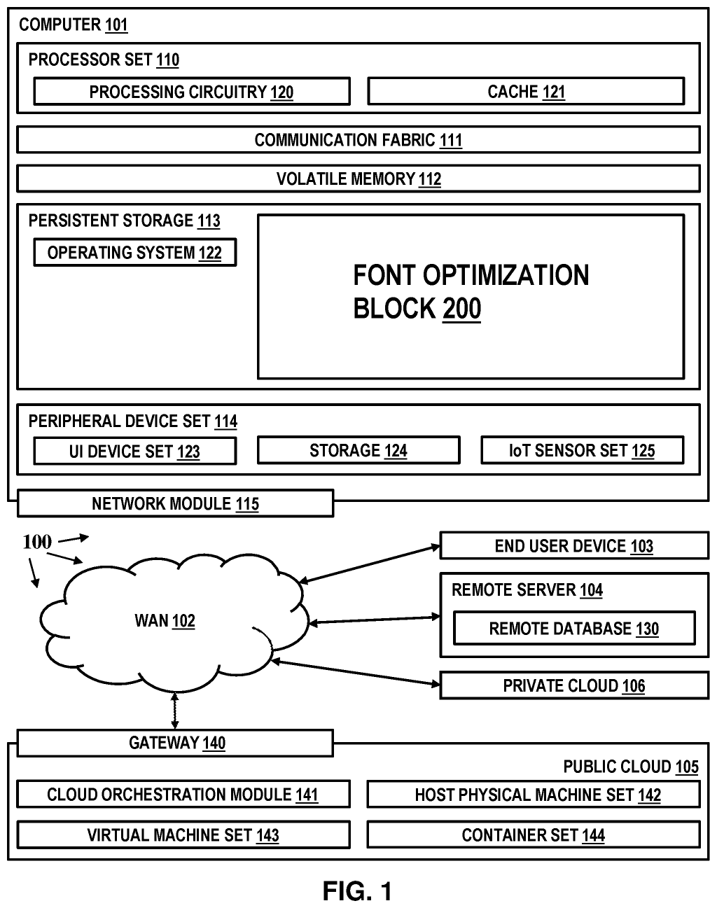

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As shown in the first Figure of this document, computing environment 100 contains an example of an environment for the execution of at least some of the computer code involved in performing the inventive methods, such as font optimization block 200 (also herein sometimes referred to as block 200). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### II. Example Embodiment

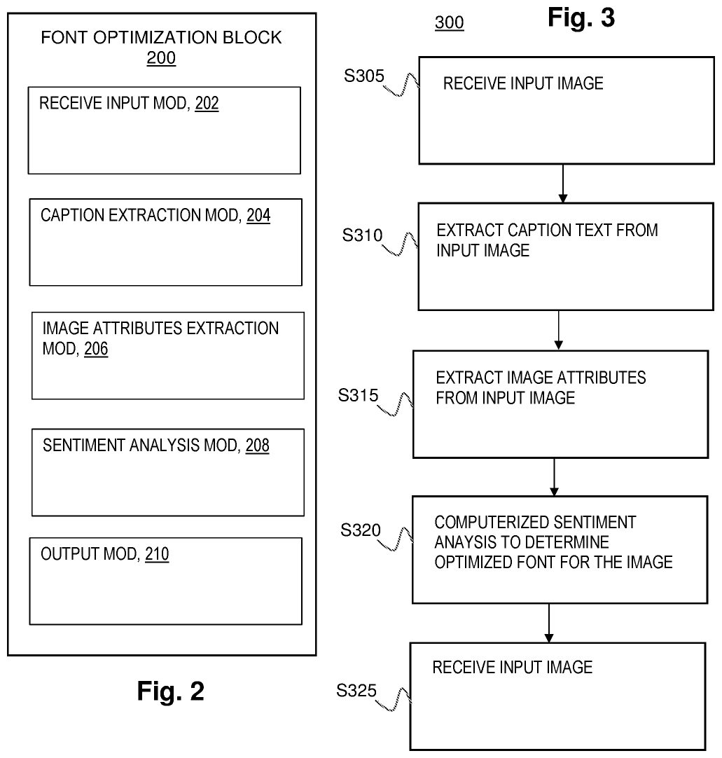

Computing environment 100 is an environment in which an example method according to the present invention can be performed. As shown in FIG. 3, flowchart 300 shows an example method according to the present invention. As shown in FIG. 2, block 200 performs or controls performance of at least some of the method operations of flowchart 300. This method and associated software will now be discussed, over the course of the following paragraphs, with extensive reference to the blocks of the first three figures.

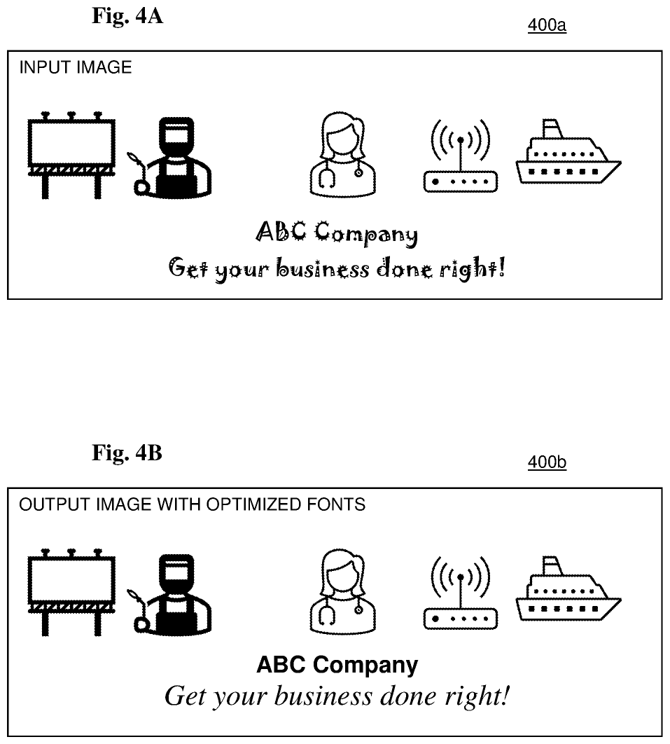

Processing begins at operation S305, where input module (“mod”) 202 receives an input image (for example, a photograph) that includes a image portion and “caption text” (for example, an overlaid caption or some text that is captured in a photograph). This input image 400a is shown in FIG. 4A. Alternatively the input can be other types of multimedia presentations or files, such as: (i) an audiovisual presentation with “caption text” shown in the video; or (ii) an audio presentation with “caption text” that accompanies the audio file. One example of an audio presentation would be a web page that includes caption text describing (for example, transcribing) the contents of the video. Regardless of whether the input multimedia presentation is an image, a video presentation or an audio presentation, it must include some form of caption text that can be changed in font (that is, typeface, text color and special formats (for example, bold, underline, strikethrough, superscript, subscript, italics and the like).

Processing proceeds to operation S310, where caption extraction mod 204 extracts the caption text from the input image.

Processing proceeds to operation S315 where image attributes extraction mod 206 extracts a plurality of image attributes relating to the caption text and image portion.

Processing proceeds to operation S320 where sentiment mod 208 applies sentiment analysis to the plurality of image attributes to select a selected font determining a sentiment associated with the plurality of image attributes. This sentiment analysis includes artificial intelligence, machine learning and the use of a computer based model, as will be understood by those of skill in the art of computerized sentiment analysis.

Processing proceeds to operation S325 where output mod 210 generates an output image that includes the image portion of the input image and the caption text presented in the selected font. Output image 400b of FIG. 4B shows the output image when input image 400a is input. Specifically, the font has changed in three ways: (i) the typeface has changed from a typeface called Jokerman to two typefaces (Arial for company name and Times New Roman for the company slogan); (ii) a change from bright purple text to black text for the caption text (not shown in the patent drawings because they are black-and-white); and (iii) changes in special formats (company name in bold text, company slogan in italics). All of these changes are likely to set a more professional mood, a sort of stoic but optimistic mood to emphasize that the image and caption text, taken as a whole, is about productivity and especially productivity in a professional environment.

### III. Further Comments and/or Embodiments

Some embodiments include a mechanism to use Natural Language Processing to identify the objects characteristics. These object characteristics are then applied/matched to those characteristics to fonts in order to find the font that has a similar personality characteristic as the object. Once the font is matched and a score threshold is met, the system generates the characteristic font to represent the object. The type of information generated is font type and various metadata for the font such as font size, capitalization, italic, underline, bold, strikethrough, color, highlight, etc. For example, a laser tag facility advertisement might use a font with all capitalized letters with varying sizes to represent chaos along with an image portion showing a chaotic game of laser tag in progress.

Implementation of an embodiment of the present invention will now be discussed in the following paragraphs.

FIRST OPERATION: build a font AI (artificial intelligence) model. A font model with associated characteristics is built and iterated over a list of font types.

SECOND OPERATION: For each font type, associate it with characteristics, including code to handle synonyms of those characteristics. This could be achieved by rules based machine learned using a ground truth file set of existing event documents/flyers. For example: Font type Comic Sans MS portrays a light, whimsical, comical characteristic. Social media post likes/dislikes could be used to identify which combinations, of metadata work best for various scenarios.

THIRD OPERATION: iterate over the various metadata attributes that a font could possess (size, color, bold, italics, underline, etc.) and associate a characteristic for each of those metadata attributes various values. For example, Bold attribute portrays emphasis and attention.

FOURTH OPERATION (the fourth and subsequent operations may be called “generating a font flow”—generate a font AI model.

FIFTH OPERATION (the fifth and subsequent operations may be called “generating a font flow”—input text related to a multimedia object (for example, use case for output text).

SIXTH OPERATION: perform text analytics (NLP/machine learning) to extract the object's and its characteristics from the text.

SEVENTH OPERATION: obtain one characteristic of the object that was identified in the previous operation.

EIGHTH OPERATION: using the AI model generated earlier in the method, perform NLP/AI on the characteristic identified in the previous sub-operation.

NINTH OPERATION: The characteristic is matched based on synonym match in the model, and the corresponding font attribute is generated.

TENTH OPERATION: a score engine is utilized, where each font attribute is provided a score value. If the text is a proper noun, then it will be scored higher over other words. The score is based on the closeness of the synonym match or the probability of ML model that the in past ground truth the concept was likely the best match.

ELEVENTH OPERATION repeat the ninth and tenth operations until all corresponding font attributes are identified.

TWELVTH OPERATION: If more characteristics identified in the second operation, return to the third operation—otherwise, go back to the ninth operation.

THIRTEENTH OPERATION: Score Engine—consolidate all of the findings generated in the seventh operation and sum the similar font attribute scores together.

FOURTEENTH OPERATION: If the attribute score meets the score threshold, then it is added to the full list of font types and corresponding font attributes.

FIFTEENTH OPERATION: Generate the full list of font types and corresponding font attributes.

SIXTEENTH OPERATION: Optionally: the font information could be autogenerated into electronic text for the words to be transformed based on the font attribute information (for example, Font Type: Free style Size: 20, italic to convey a message for a dance event for free style dance).

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Set of thing(s): does not include the null set; “set of thing(s)” means that there exist at least one of the thing, and possibly more; for example, a set of computer(s) means at least one computer and possibly more.

What is claimed is:

1. A CIM comprising:
receiving an input image data set including information of an input image that includes an image portion and caption text;
extracting the caption text from the input image;
extracting a plurality of image attributes relating to the caption text and image portion;
applying computerized sentiment analysis to the plurality of image attributes to select a selected font optimized for sentiment(s) associated with the plurality of image attributes; and
generating an output image that includes the image portion of the input image and the caption text presented in the selected font.

2. The CIM of claim 1 further comprising displaying the output image on a display device.

3. The CIM of claim 1 wherein the selected font includes a selected typeface that is optimized for sentiment(s) associated with the plurality of image attributes.

4. The CIM of claim 1 wherein the selected font includes a selection of one of the following special font features: bold, underline, italics, strikethrough, subscript and/or superscript.

5. The CIM of claim 1 wherein the selected font includes a selected type color that is optimize for sentiment(s) associated with the plurality of image attributes.

6. A CIM comprising:
receiving an input video data set including information of an input video that includes a video portion and caption text;
extracting the caption text from the input video;
extracting a plurality of image attributes relating to the caption text and image portion;
applying computerized sentiment analysis to the plurality of video attributes to select a selected font optimized for sentiment(s) associated with the plurality of video attributes; and
generating an output video that includes the video portion of the input video and the caption text presented in the selected font.

7. The CIM of claim 6 further comprising displaying the output video on a display device.

8. The CIM of claim 6 wherein the selected font includes a selected typeface that is optimized for sentiment(s) associated with the plurality of video attributes.

9. The CIM of claim 6 wherein the selected font includes a selection of one of the following special font features: bold, underline, italics, strikethrough, subscript and/or superscript.

10. The CIM of claim 6 wherein the selected font includes a selected type color that is optimize for sentiment(s) associated with the plurality of video attributes.

11. A CIM comprising:
receiving an input audio data set including information of an input audio presentation that includes an audio portion and associated visual presentation information that includes caption text;
extracting the caption text from the associated visual presentation information;
extracting a plurality of audio attributes relating to the caption text and audio portion;
applying computerized sentiment analysis to the plurality of audio attributes to select a selected font optimized for sentiment(s) associated with the plurality of audio attributes; and
generating an output audio that includes the audio portion of the input video and the associated visual presentation information with the caption text in the selected font.

12. The CIM of claim 11 further comprising displaying the output audio presenting the associated visual presentation information with the caption text in the selected font on a display device.

13. The CIM of claim 11 wherein the selected font includes a selected typeface that is optimized for sentiment(s) associated with the plurality of audio attributes.

14. The CIM of claim 11 wherein the selected font includes a selection of one of the following special font features: bold, underline, italics, strikethrough, subscript and/or superscript.

15. The CIM of claim 6 wherein the selected font includes a selected type color that is optimized for sentiment(s) associated with the plurality of audio attributes.
